(19) United States
(12) Patent Application Publication
(10) Pub. No.: US 2024/0403836 A1
(43) Pub. Date: Dec. 5, 2024

(54) PRODUCT CIRCULATION METHOD AND PROCESSOR SYSTEM

(71) Applicant: HITACHI, LTD., Tokyo (JP)

(72) Inventors: Hiroki NAKATSUCHI, Tokyo (JP); Takashige IWAMURA, Tokyo (JP); Shinichi TANIGUCHI, Tokyo (JP); Yoshiki YONAMOTO, Tokyo (JP); Daisuke MATSUKA, Tokyo (JP); Kotaro CHIBA, Tokyo (JP); Osamu HOSHINO, Tokyo (JP)

(21) Appl. No.: 18/691,076

(22) PCT Filed: Sep. 26, 2022
(86) PCT No.: PCT/JP2022/035736

§ 371 Date: Mar. 12, 2024

(30) Foreign Application Priority Data
Dec. 28, 2021 (JP) 2021-213797

(51) Int. Cl. G06Q 10/20

(52) U.S. Cl. CPC G06Q 10/20

(57) ABSTRACT

Aim for early promotion of a circular economy. After the start of use of a product including a plurality of modules, a module to be removed included in the product is replaced with a new module (a module of which a value has improved in a predetermined product value item compared to the module to be removed). Note that the new module is a module completed by article circulation of a module removed from the product or another product.

### TECHNICAL FIELD

The present invention relates to a product circulation method and a processor system. The present invention claims priority to Japanese Patent Application No. 2021-213797 filed on Dec. 28, 2021, and for designated countries where incorporation by reference to documents is permitted, the content described in the application is incorporated herein by reference.

### BACKGROUND ART

In promoting the circular economy, 4Rs ((Reuse (reuse), Reduce (reduce), Repair (repair), and Remanufacture (remanufacturing)) are important concepts.

Patent Literature 1 discloses a repair technique for a combustion facility among the 4Rs. More specifically, in the abstract of Patent Literature 1, an object is to “provide a facility management system that efficiently supports operation management of a combustion facility”, and it is described that “in a facility management system 1, data of an operation status and a management status of a combustion facility of a factory 5 is transmitted to a server 11 of a system manager 29 on a constant or regular basis. The server 11 immediately responds (notification to a factory facility manager 7, repair request to a maintenance company 13, parts order to a manufacturer 9, or the like) when there is an abnormal operation of the combustion facility. In addition, the server 11 gives management advice for failure prevention and advice for optimal driving to the factory facility manager 7”.

In addition, paragraph 0037 of Patent Literature 1 describes that “the server 11 not only monitors the daily combustion facility 39, but also notifies the factory facility manager 7 and the manufacturer 9 when a member used in the combustion facility 39 becomes a recall target, for example. In addition, when a member used in the combustion facility 39 is discontinued, a substitute member is introduced to the factory facility manager 7. In addition, advice (for example, introduction of high-performance parts) for facility update or modification of the combustion facility 39 is given to the factory facility manager 7”.

Note that, in the present specification, an action of making an article (refers to a product, a part, a material, and the like) available again as an article is referred to as “article circulation”. Examples of the article circulation include reuse, repair, remanufacturing, refurbishing, and recycling.

### CITATION LIST

### Patent Literature

Patent Literature 1: JP 2003-15729 A

### SUMMARY OF INVENTION

### Technical Problem

For early promotion of the circular economy, it is important to achieve at least the following three goals in parallel.
Improving items relating to the value of a product (hereinafter, collectively referred to as product value item), such as a function, a performance, a durability, an appearance, or a life of the product.
Prolonging a period from when the product is manufactured and to when the product is discarded.
Promoting article circulation.

However, the technique described in Patent Literature 1 does not disclose at least article circulation, and it is difficult to achieve the above-described three goals in parallel. The present invention has been made in view of the above problems, and an object thereof is to achieve the above-described three goals in parallel. Other objects of the present specification will be apparent from the embodiment.

### Solution to Problem

The present application includes a plurality of means for solving at least a part of the above problems, but examples thereof are as follows.

A circulation method of a product including a plurality of modules according to an aspect of the present invention for solving the above problem includes:
removing a module to be removed from a first product that has started to be used; and
attaching a new module to the first product, the new module being a substitute for the module to be removed,
the new module being a module of which a value has improved in a predetermined product value item compared to the module to be removed, and
the new module being a module completed by performing article circulation of at least one of the following:
the module to be removed related to the first product; and
a module removed from a second product different from the first product.

### Advantageous Effects of Invention

According to the present invention, it is possible to contribute to early promotion of the circular economy.

### BRIEF DESCRIPTION OF DRAWINGS

FIG. 1 is a diagram illustrating an ecosystem.

FIG. 2 is a diagram illustrating a concept of an upcycle of a product.

FIG. 3 is a diagram illustrating a processor system of a sharing organization.

FIG. 4 is a diagram illustrating a processor system of a manufacturer.

FIG. 5 is a flowchart illustrating a first processing example of article circulation support processing by the processor system.

FIG. 6 is a flowchart illustrating a second processing example of the article circulation support processing by the processor system.

FIG. 7 is a flowchart illustrating a third processing example of the article circulation support processing by the processor system.

FIG. 8 is a flowchart illustrating a fourth processing example of the article circulation support processing by the processor system.

FIG. 9 is a diagram illustrating a more developed ecosystem.

### DESCRIPTION OF EMBODIMENTS

Hereinafter, embodiments of the present invention will be described with reference to the drawings. Although a part has already been described, meanings of terms used in the present specification are as follows.
An example of the article is an object such as a product, a module, a part, or a material.
A product refers to a manufactured article. It is first conceivable that the product is an article manufactured by a manufacturer and is an article in a form used by a user, but the product may be a part. For a manufacturer of the part, it is a product.
A value item refers to an item related to the value of an article, such as a function, a performance, a durability, an appearance, or a life of the article. The value item of the product may be referred to as a product value item, the value item of the article may be referred to as an article value item, and the value item of the module may be referred to as a module value item.
An upgrade refers to a change of a part or the whole of a product so as to improve the value of items related to the value of the product (hereinafter, collectively referred to as product value item), such as the function, the performance, the durability, the appearance, or the life of the product. Specific examples thereof include a change of hardware represented by article circulation to be described later, as well as an update of a program or data used in the program. Note that “value improvement of a value item” may be simply referred to as “improvement of a value item”.
Article circulation refers to an action of converting an article (more preferably, it is an article that is no longer used, a discarded article, or an article removed from a product) into a form that can be used again as an article. Examples of the article circulation include reuse, repair, remanufacturing, refurbishing, recycling, and cleaning.
An upcycle refers to performing both of the following (1) and (2).
   (1) Performing an upgrade, and
   (2) converting such that the article attached to the product by replacement is an article completed by the article circulation, or the upgraded product is a product completed by the article circulation.
Completion of an article refers to an action of bringing the article into a usable state. Examples of the completion of the article include the examples described in the article circulation, and also include manufacture of the article that is not circulated.
A history refers to an aggregate of matters (matter) that the article has passed so far.

### <Organization Constituting Ecosystem>

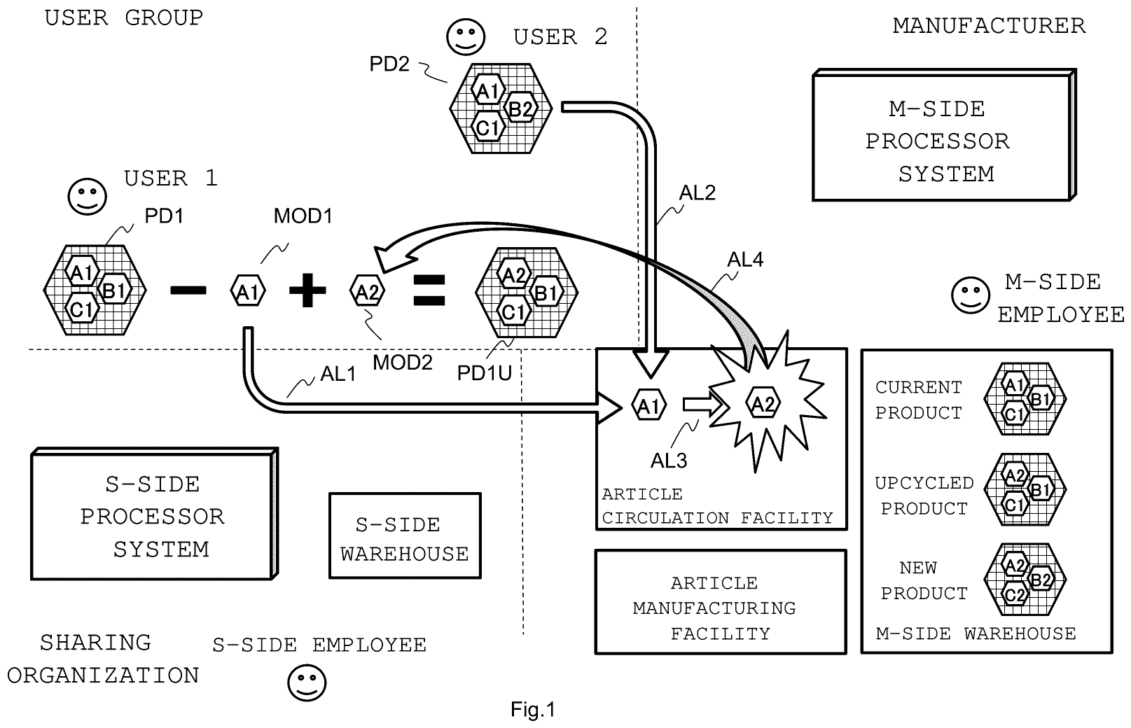

FIG. 1 is a schematic diagram illustrating an organization included in an ecosystem related to a circular economy. The ecosystem includes a manufacturer organization (hereinafter, may be referred to as a manufacturer), a sharing organization, and a user group. Note that the ecosystem does not need to include all these organizations. In addition, in the ecosystem, one organization may also play a role of another organization. Note that the organization is a concept including, for example, a corporation such as a company, an association, a group, and the like. In addition, the organization may be an individual.

### <<Role and Component of Each Organization>>

Hereinafter, roles and representative components of the organizations included in the ecosystem will be described. In the drawings and the description, “M side” at the head means “used by the manufacturer”, “S side” at the head means “used by the sharing organization”, and “U side” at the head means “used by the user”. In the description of the action, when a subject is an organization such as “manufacturer” or “sharing organization”, the description may be paraphrased as a description using a member (for example, an employee) of the organization as the subject.

The manufacturer (organization) is an organization that manufactures products and supplies the products to the users and other organizations (for example, the sharing organization and other manufacturers). In FIG. 1, the product is indicated by a hexagon (the inside is painted with a graph check). Note that a white hexagon with alphabets and numbers inside indicates a module to be described later.

The manufacturer has an M-side processor system, an M-side warehouse, an article manufacturing facility, and an article circulation facility. In addition, one or more employees (M-side employees) employed by the manufacturer perform the aforementioned roles by using or managing the M-side processor system, the M-side warehouse, the article manufacturing facility, and the article circulation facility.

The sharing organization is an organization (provider) that provides a sharing service. Note that the sharing organization rents a sharing target product to a customer of the organization. Note that once the product has been rented, it is transported to a place (land or building (warehouse in FIG. 1)) managed by the sharing organization. Note that the sharing organization does not necessarily have the ownership of the product to be rented. In addition, the sharing organization may be an organization that mediates product rental between customers. Note that a company that leases or rents products is an example of the sharing organization.

The sharing organization has an S-side processor system and an S-side warehouse. In addition, one or more employees (S-side employees) employed by the sharing organization perform the aforementioned roles by using or managing the S-side processor system and the S-side warehouse.

The user is a person and an organization that uses the product manufactured by the manufacturer. Note that the product used by the user may be a product acquired by purchase from a manufacturer or an intermediate company (for example, a distributor, a retailer, or a secondhand goods dealer), or may be a product borrowed from the sharing organization.

Note that the ecosystem may include other organizations.

### <<Designation of Products>>

Note that, in the ecosystem of FIG. 1, the following products are distributed or used.
A current product and a new product. Both products are products manufactured without the article circulation. The new product has an improved product value item than the current product. An example of a product value item related to the environment is a power consumption amount related to carbon neutral. Note that the current product is a product that is currently on sale or a product that has been sold in the past.
An upcycled product is a product whose predetermined product value item has been upgraded by upcycling the current product or the upcycled product. Note that from the viewpoint of the predetermined product value item, typically, the new product is comparable to or superior to the upcycled product. This is because the entire product can be reviewed in the case of the new product. In this specification, the following is also referred to as the upcycled product.
   A product including at least a part of a module completed by the article circulation while reviewing the entire product.
   A product obtained by a manufacturer collecting the current product or the upcycled product that has been used by a certain user and replacing at least a part of the product with a module completed by the article circulation.

### <<Circular Economy Promotion in Ecosystem>>

In order to promote the circular economy in the ecosystem illustrated in FIG. 1, it is important to set at least the following three goals in parallel.
“Value improvement”: improving the product value item.
“Extension of product utilization period”: prolonging the period from when the entire product is manufactured to when the entire product is discarded.
“Promotion of resource circulation”: promoting the article circulation.

The followings will be supplemented.

First, “value improvement” will be supplemented. In order to take in new users and acquire users from competitors, the manufacturer secures profits (may also be sales expansion) by supplying users with the new products having product value items more suitable for user needs than the current products. Therefore, the manufacturer aims to improve the product value items by putting funds into research and development. Note that examples of the product value item include a function, a performance, a capacity, a weight, a size, a durability, an appearance, or a life of the product, and examples related to environmental problems include energy efficiency (that is, the power consumption amount) at the time of using the product, a CO2 generation amount, and a generation amount of a substance that affects the environment (CO2 is also an example). Therefore, continuing the “value improvement” is an important point that contributes to the solution of social problems such as environmental problems in addition to the viewpoint of securing profits of the manufacturer.

In addition, in a case where the user is an individual, when the “value improvement” is attempted even during the promotion of the circular economy, the user (in particular, an individual) naturally contributes to the promotion of the circular economy by purchasing the upcycled product according to a desire, and thus the circular economy can be promoted earlier. Even when the user is not an individual, similarly, purchasing a product that satisfies a requirement desired by the user naturally contributes to the promotion of the circular economy.

Next, the “extension of product utilization period” will be supplemented. In each of the processing described in the article circulation, the energy consumption amount and the amount of articles that cannot be circulated and are discarded are different. The examples thereof are recycling and repair. In the recycling, when waste is converted into a recycled material, processing such as sorting, crushing, and melting are performed, and thus there is a tendency that an environmental load such as an amount of energy consumed is large as compared with the repair. Therefore, the entire product should not be recycled, but a part of the product should be repaired or cleaned with less environmental load than the recycling.

### <<<Outline of Mechanism by Which Ecosystem Achieves Three Goals in Parallel>>>

The circulation method by the ecosystem for contributing to achieving the three goals in parallel is as follows (all may not be essential). Note that the parentheses indicate correspondence with the illustration of FIG. 1, but are merely examples.
A product is composed of a plurality of modules (in FIG. 1, products PD1 and PD2 are indicated by hexagons (the inside is painted with a graph check). Note that the module is a white hexagon, and is illustrated in a shape in which an alphabet (indicating the type of the module) and a number (indicating the value according to a predetermined module value item (it is assumed that the value is improved as the value increases) are described inside).
The module to be removed is removed from a first product (the product PD1 used by the user 1) that has started to be used (remove a module (type A, value 1) MOD1 from the product PD1), and a new module as a substitute for the module to be removed is attached to the first product (attach a module (type A, value 2) MOD2 to the product PD1). This action may be performed by any of the user, the manufacturer, and the sharing organization. This is a point that contributes to the “extension of product utilization period”.
The new module is a module in which the value of the predetermined product value item is improved as compared with the module to be removed (the value 2 of the module MOD2 is better than the value of the module MOD1). This is a point that contributes to the “value improvement”.
The new module is a module (arrow AL4) completed by performing the article circulation (arrow AL3) of at least one of the following. Note that the completion is performed by a manufacturer or an organization entrusted to the manufacturer. This is a point that contributes to the “promotion of resource circulation”.
   The module to be removed (arrow AL1) related to the first product, and
   a module (arrow AL2) removed from the second product (the product PD2 being used by the user 2) different from the first product.

As a result, the first product is upgraded, that is, upcycled (the product PD1 is upcycled to a product PD1U) with the module completed by the article circulation.

### <<<Regarding Module>>>

The module is an article that can be removed and attached (replaced) from a product. In FIG. 1, a module (may be referred to as a field replaceable unit (FRU)) replaceable at the user's use site has been described as an example. However, the module may be a replaceable module within the manufacturer's facility.

In addition, the module may be a module that provides a software defined technique. Hereinafter, the module may be referred to as a software defined module. The software defined module is a module as follows.
One having at least a processor and a memory resource.
The memory resource stores a program (hereinafter, may be referred to as a module-side program for distinction) and data used by the program (similarly, may be referred to as module-side data).
The processor executes the module-side program to implement a predetermined function provided by the module.
The module-side program or the module-side data can be updated.

Note that examples of the processor and the memory resource, and a method of using the module-side program stored in the memory resource and the data (may be referred to as module-side data) used by the program by the processor are similar to those described in a processor system described later.

### <<<<Regarding Specification and Model Number of New Module>>>>

Note that, in order to facilitate management of a circulation data sheet generated by the manufacturer in addition to management of the new module by the manufacturer (inventory, specification, and the like), a model number associated with a predetermined specification may be assigned to the new module, and the new module may be completed to a specification conforming to the use (it is not essential).

### <<<<Preferred Form of Module Design or Completion>>>>

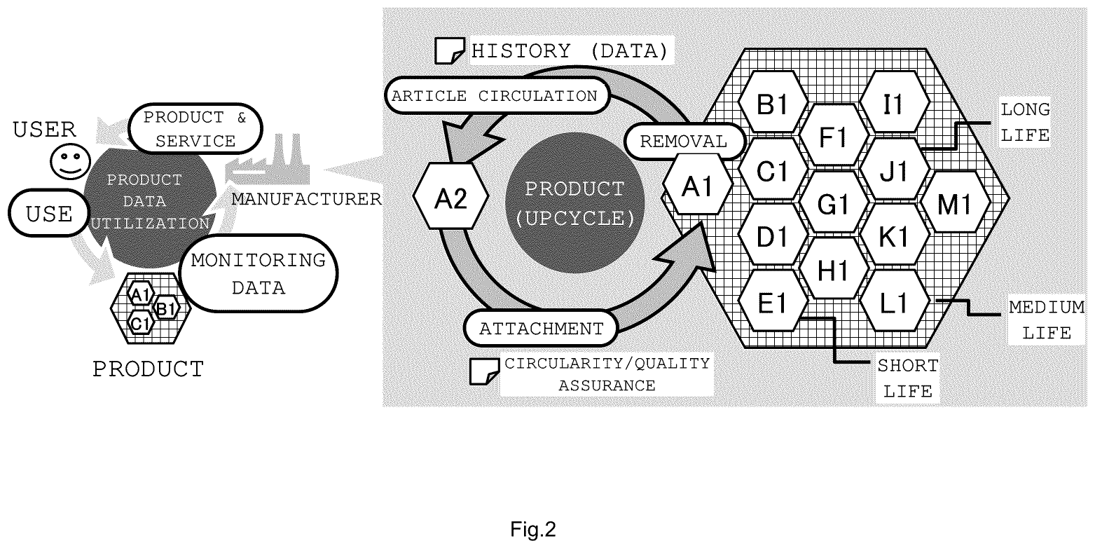

Note that the module is composed of one or more parts. In the following description, a case where the module is composed of a plurality of parts will be described as an example. In addition to FIG. 1, FIG. 2 is also used in the present description.

In designing, manufacturing, or completing the module, the manufacturer preferably selects parts constituting the module in consideration of one or more of the following (but not essential).
The durability and the life of the parts. It is preferable that the module is composed of the parts having the same degree of durability and life. By doing so, it is possible to reduce the number of parts (or remaining usage period or number of times) that are still available in the removed module and to reduce the number of parts subjected to the article circulation. With such a configuration, as illustrated in FIG. 2, even when the life as the part is replaced with the life as the module and the product is maintained, the part can be used up to the durability and life closer to the limit.
Appearance. A dress designer designs an appearance of the product by combining colors, textures, and shapes (hereinafter, collectively referred to as design factors) in order to make the user feel an aesthetic feeling. In a case where there is a plurality of modules including an appearance part in the product, it is preferable to reduce the number of modules that need to be replaced when a predetermined design factor is to be changed by adjusting a boundary between the modules and a boundary between the design factors.
Relevance with functions provided by the product. In order to easily improve a predetermined function while reducing the number of modules to be replaced, it is ideal to combine the parts related to the predetermined function into one or several modules.

### <<<Reason for Replacing Product Module>>>

The reason why the manufacturer, the user, or the sharing organization removes the aforementioned “module to be removed” from the product and attaches the aforementioned “new module”, that is, replaces the module, is, for example, as follows.
Due to the failure and life of the module to be removed.
To upgrade the product. More specifically, the followings are the examples.

(Example 1) In a case where it is necessary to improve a predetermined product value item of a current product due to environmental regulations or the like, it is conceivable to replace the module to be removed with a new module although the module to be removed has not failed or reached the end of its life.

(Example 2) In the case of the software defined module, it is conceivable to improve the value item (examples include a processing speed, a function application range, a speed, a performance, and a degree of security measure) related to the function provided by the module by updating the module-side program or the module-side data. However, when the hardware requirement of the module assumed by the updated module-side program becomes strict, the update cannot be executed. Therefore, in order to maintain or improve the value item provided by the module (or the module-side program), it is conceivable to replace the module to be removed (not failing or reaching the end of its life) with a new module (which satisfies the aforementioned hardware requirement). Examples of such hardware requirement include the presence or absence of a graphics processing unit (GPU), the presence or absence of a security chip, a processor speed, a memory capacity, the presence or absence of a predetermined type of sensor, and a part generation. Note that from the viewpoint of optimization of the program scale, a program module (for example, a device driver) for operating an old part (for example, a peripheral device) may be excluded from the module-side program by update. Even for this reason, replacement with the new module may be performed.

The above is the specific example of a case where the reason is the product upgrade.

Next, each organization or component will be described in more detail.

### <Details of Component of Manufacturer>

### <<M-Side Warehouse>>

The M-side warehouse illustrated in FIG. 1 is a building in which products manufactured or completed by the manufacturer are stored (including temporary storage before delivery to the user or the sharing organization). In FIG. 1, a current product, an upcycled product, and a new product are illustrated as storage targets, but it is not always necessary to store all the products (for example, upcycled products). Note that the M-side warehouse may store modules, parts, and materials constituting the product.

### <<Article Manufacturing Facility>>

The article manufacturing facility illustrated in FIG. 1 is a facility (group) used when manufacturing a current product or a new product, and manufacturing is performed by the M-side employee using the facility. Note that some or all of the article manufacturing facility and the article circulation facility may be common. Examples of the article manufacturing facility include a press machine, a cutting machine, an additive manufacturing device (including build-up welding facility), an injection molding machine, a blow molding machine, a rolling machine, and casting facility. Note that the article manufacturing facility may be owned by an organization to which manufacturing is entrusted by the manufacturer, and may be used by an employee of the manufacturing entrusted organization.

### <<Article Circulation Facility>>

The article circulation facility illustrated in FIG. 1 is a facility (group) for the article circulation, and the M-side employee uses the facility to perform the article circulation. The article circulation facility is, for example, as follows:
repair: cutting machine (polish or scrape a portion to be repaired), additive manufacturing device (restoration of worn or damaged repair portions), a coating facility, a coating peeling facility, an adhesion facility, a facility that promotes self-repair in the case of articles made of self-repairing materials (a heating facility such as a heater or a laser irradiation facility, a power supply facility for applying a voltage or a current to an article, a humidifier, a container storing a restoration accelerator such as water, and the like)
recycling: a crusher, a classifier, a washer, a dehydrator, a granulator, a melting furnace, and a heating facility.
Cleaning: a cleaner, a washer, and a blower.
Update of program or data: a processor system, a computer, and a network.
A measuring device or an inspection device (a camera, a micrometer, a caliper, a gravimeter, a component analysis device, and a shape measurement device). The measuring device or the inspection device is used to select an article circulation method such as repair or cleaning, and determine which position within the article is to be subjected to the article circulation.

The above is an example. Note that the article manufacturing facility may be owned by the organization to which the manufacturer entrusts the article circulation, and may be used by the employee of the entrusted organization.

### <<<M-side Processor System>>>

The M-side processor system is a processor system used by the M-side employee. The M-side processor system will be described in detail later.

### <Details of Component of Sharing Organization>

### <<S-side Warehouse>>

The S-side warehouse illustrated in FIG. 1 is a building that stores products to be rented. Note that the S-side warehouse may store modules and parts constituting the product. Examples of these articles include spare articles to be attached. Examples of these articles include articles to be removed and delivered to the manufacturer.

### <<S-Side Processor System>>

The S-side processor system is a processor system used by the S-side employee. The S-side processor system will be described in detail later.

### <Processor System>

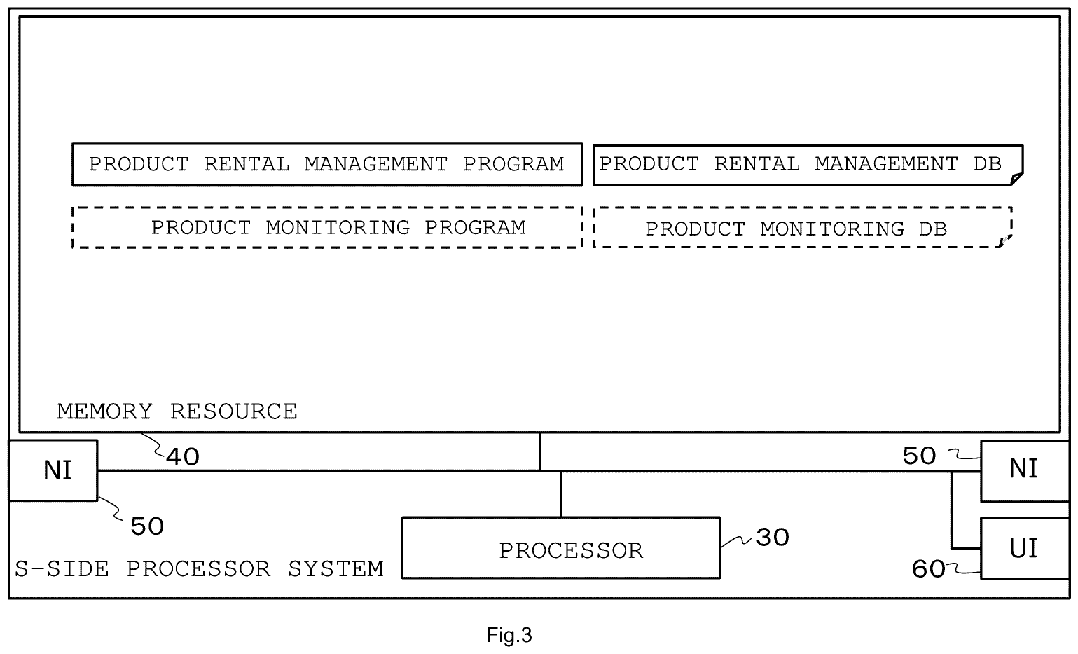

The hardware of the processor system will be described with reference to FIG. 3. In addition, a program and data executed by the processor system will also be partially described. Note that FIG. 3 is a diagram mainly illustrating the S-side processor system, but these descriptions are also applied to the M-side processor system.

As illustrated in FIG. 3, the processor system has one or more processors 30, one or more memory resources 40, one or more network interface devices (NIs) 50 (a plurality of NIs are illustrated in FIG. 3), and one or more user interface devices (UIs) 60.

The processor 30 is an arithmetic device that reads various programs stored in the memory resource 40 and executes processing corresponding to each program. Note that the processor 30 is, for example, a microprocessor, a central processing unit (CPU), a graphics processing unit (GPU), a field programmable gate array (FPGA), or another semiconductor device that can perform arithmetic calculation.

The memory resource 40 is a storage device that stores various data. Note that the memory resource 40 is a nonvolatile or volatile storage medium such as a random access memory (RAM) or a read only memory (ROM). In addition, the memory resource 40 may be a rewritable storage medium such as a flash memory, a hard disk, or a solid state drive (SSD), or may be a universal serial bus (USB) memory, a memory card, a hard disk, or the like.

The NI 50 is a communication device that performs data communication with an external device. The NI 50 performs data communication with the external device via a predetermined communication network such as the Internet. Note that the data communication between the processor system and the computers of the respective organizations is executed via the NI 50 unless otherwise specified below.

The UI 60 is an input device that receives an input of an instruction of the user (operator) to the processor system and an output device that outputs data and the like generated by the processor system 100. Examples of the input device include a keyboard, a touch panel, a pointing device such as a mouse, and a sound input device such as a microphone. In addition, examples of the output device include a display, a printer, and a voice synthesis device. Note that, unless otherwise specified below, input/output of the data between the employee and the processor system is executed via the UI 60.

Note that examples of the processor system include a device itself such as a personal computer, a server computer, a cloud server, a notebook computer, a tablet computer, or a smartphone, an aggregate of devices of the same type, or an aggregate of combinations thereof. For example, an aggregate of the tablet computer used by the employee or the user for input and display confirmation work and the cloud server is also a processor system.

In a case where the program stored in the memory resource 40 is executed, the processor 30 reads and executes the program from the memory resource 40, whereby the processor performs processing of the program described in the present specification. In the following description, the subject of the processing of the program is described as a “program”, but the processing content of the program can also be said to be processing performed by the processor or the processor system. Therefore, the description of the processing using the program as the subject may use the processor or the processor system as the subject.

In addition, some or all of the configurations, functions, processing means, and the like of the present system may be implemented by hardware, for example, by designing with an integrated circuit. In addition, in the present system, a part or all of each function can be implemented by software, or can be implemented by cooperation of software and hardware. In addition, the present system may use hardware having a fixed circuit, or may use hardware capable of changing at least a part of the circuit.

Each DB (abbreviation of database) in the memory resource 40 described below may have a file or the like or a data structure other than the database as long as the DB is an area in which data can be stored. In addition, the program may not be divided as illustrated in FIG. 3. That is, one program may also serve as a plurality of programs. Alternatively, the opposite may be applied. That is, one or more programs only need to be able to perform processing of each program illustrated.

In addition, in order to simplify the description, the data stored in each DB will be described on the premise that data other than the program storing the data can be directly referred to. In a case of a program that is not based on such a premise, the program to be referred to can be implemented by sending some request to the program storing data and obtaining data to be referred as a return value.

### <S-Side Processor System>

The S-side processor system will be described with reference to FIG. 3. The memory resource of the S-side processor system stores the following. Note that the processor of the S-side processor system reads and executes the program stored in the memory resource to perform processing of the program described below.
Product rental management DB. The DB stores customer data as well as maintenance and rental history of the target product.
Product Rental Management Program. The program stores the data described in the aforementioned product rental management DB in the product rental management DB in response to the input from the customer or the S-side employee. The program also reads data from the product rental management DB and displays the data or processed data obtained by processing the data on the UI of the customer or the S-side employee. The product rental management program may transmit the data stored in the product rental management DB or the processed data (for example, the maintenance history or the rental history of each product) to the M-side processor system.

The program and the data have been described above. Note that the “customer” for the sharing organization is the past, current, or future “user” of the product. There is a case where a product is temporarily unused after being used in the past even when the product is not currently used, or there is a user who is under consideration to receive a product rent immediately after subscribing to a subscription service, and these may be managed using the aforementioned program and the DB.

In addition, the memory resource of the S-side processor system may store a product monitoring program and a product monitoring DB to be described later. The product rental management program may perform the aforementioned processing with reference to the product monitoring DB.

### <M-Side Processor System>

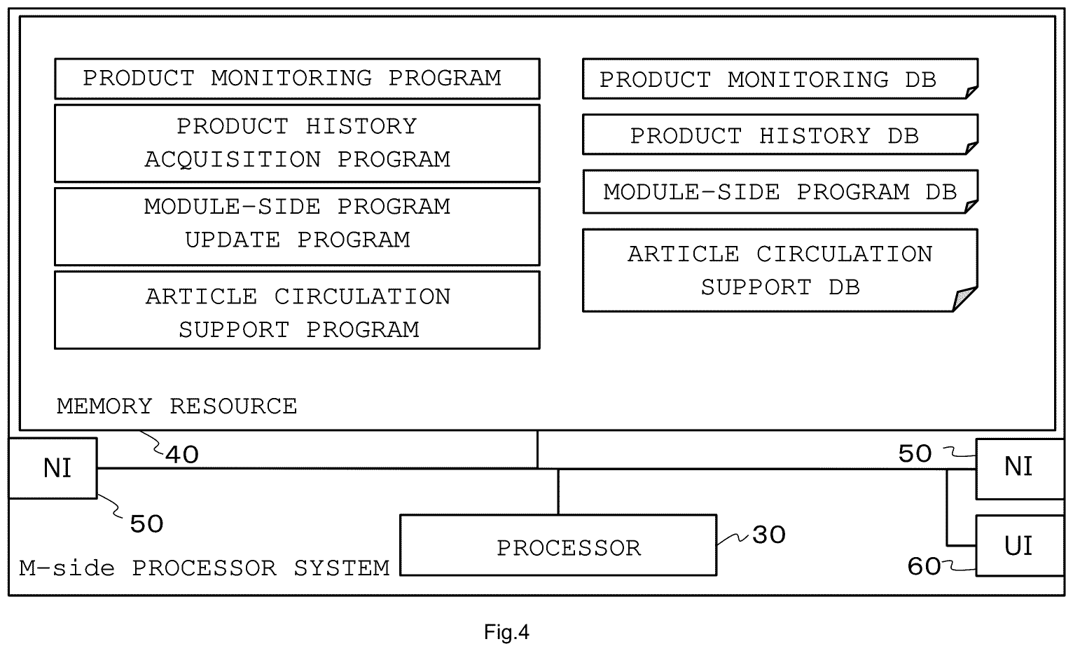

The M-side processor system will be described with reference to FIG. 4. The memory resource of the M-side processor system stores the following. Note that the processor of the M-side processor system reads and executes the program stored in the memory resource to perform processing of the program described below.
A product monitoring program. The program acquires a state of a product or a product matter (collectively referred to as monitoring data) by performing data communication with the product via a wireless or wired network, and stores the product state or the product matter in the product monitoring DB. At least one of the modules of the product includes a processor and a memory resource (in which a product data transmission program is stored), and executes the product data transmission program such that the processor transmits the state or the matter of the product (which may be a module, a part, a program that implements a function provided by the module, and its data).
A product history acquisition program. The program acquires a history of each product and stores the history in the product history DB. Note that the history of each product may be generated from data stored in the product monitoring DB, may be received from the S-side processor system of the sharing organization (for example, maintenance history and rental history), or may be generated by receiving inputs from the user, the S-side employee, and the M-side employee. In the following description, the product history may be simply referred to as a “history”.
A module-side program update program. The program causes the module of the product to update the module-side program by transmitting the module-side program stored in the module-side program DB to the product via a wireless or wired network.
An article circulation support program. The program is a program that supports the article circulation while referring to or updating an article circulation support DB. Details will be described later.
A product catalog DB. This database stores data related to the products and modules to be maintained. In this database, both a module currently attached to the product and a module not attached to the product, that is, a so-called inventory, are also subject to storage.

### <Example of Product Catalog DB>

The product catalog stores the following data.
For each product model number: the value for each specification, inventory, and value item.
For each product: an identifier, a product model number, an identifier of a module constituting a product, and a product passport
For each module model number: a specification, an inventory, an environmental load at the time of use, a value for each value item, and completion process data of a module (details will be described later).
For each module: an identifier, a module model number, and a product passport.

Note that the above storage structure is not essential, and other structures may be adopted. For example, data described as being stored for each product model number may be stored for each product, and data described as being stored for each module model number may be stored for each module. In addition, the data described as being stored for each product may also be stored for each product model number, as long as it changes only for each product model number. The same applies to the module and the module model number.

Note that the value for each value item may be a part of the specification.

### <<Product Passport>>

The product passport refers to a data group related to detailed environment-related data (examples include materials used, content ratios thereof, production methods, environmental loads, and the like) for each part constituting each product. By generating the product passport, recyclability and decomposability other than the CO2 emission amount related to the product are quantified. Note that the product passport in the present specification may be generated for each module, or may be manufactured for each product.

### <Example of History>

As an example of the product history, data obtained by time-serializing the following numerical values can be considered.
A temperature, a humidity, and an ultraviolet rays exposure amount in the usage environment of the product. It is suitable for estimating resin deterioration in a case where a resin is used as a material of the module.
A load, a vibration amount, and an amount of impact applied to the product. It is suitable for estimating wear and crack development of the module.
Values of product value items such as power consumption per unit time, fuel consumption, and processing amount per unit time.
Loads of modules or parts (CPU workload, memory usage, or the like).

In addition, examples of the product history include the following.
Product usage environment (for example, outdoor, indoor, factory, or hotel), years of installation, years of use.

### <Example of Article Circulation Support Program>

A processing example of the article circulation support program is as follows. Note that some of the following steps may be performed by the user or the employee (outside the program). When the operation is performed outside the program, the article circulation support program may receive an input of a result performed by the user or the employee and perform the next step. In addition, the examples may be used in combination. In the following description, expressions such as an identifier of a product or an identifier of a module are used, but a model number or a type of the product or the module may also be used as the identifier. For example, there is a case where only one product corresponding to the model number or type is completed, or there is only one module corresponding to the model number or type in the product.

### <<Common>>

Before describing an example of individual processing, variations and advantages common to two or more processing will be described below.
As the plurality of processing examples, the degree of improvement in the product value item due to the module replacement is displayed, but the degree of improvement may be the degree of value improvement related to the module. However, since the user does not use the module or the part alone, it is more beneficial to display the degree of value improvement as the product than to display the degree of value improvement as the module or the part.
The module to be attached may be determined in consideration of factors other than the degree of value improvement. Examples of the factor include a replacement cost, a scheduled completion time of the module to be attached (in a case of warehouse inventory exhaustion, the module itself removed from the product may be used in the article circulation to complete the module to be attached, and thus it may take time), a product stop time, an environmental load when completing the new module, an environmental load when using the new module, and a product history.
The data related to the module or the product may be processed by referring to the product catalog DB.
The following processing may further generate and display an upcycle timing (for example, timing to remove the module to be removed or timing to attach the module to be attached).

### <<Replacement of Module That Has Reached End of Its Life or Has Failed (Or Is Close to That Event)>>

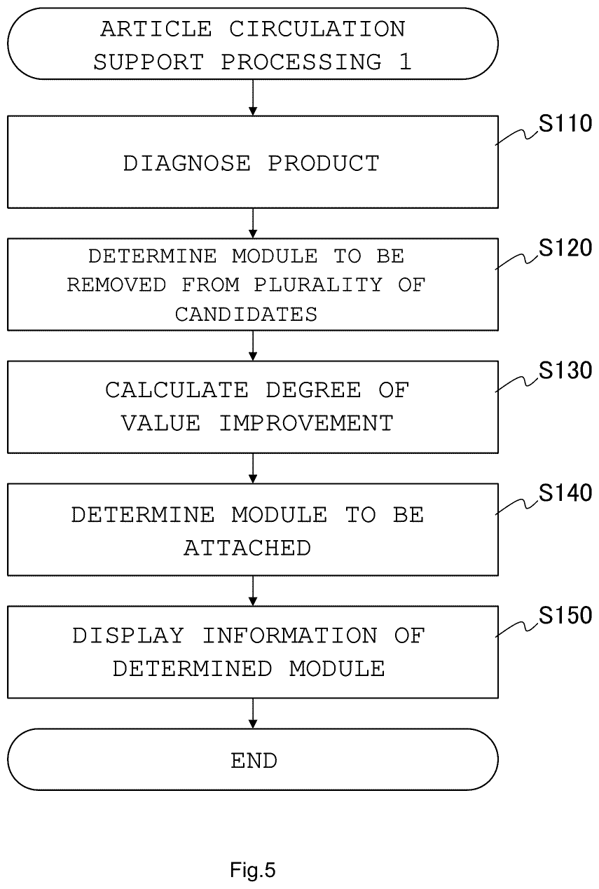

FIG. 5 is a processing example of the article circulation support program in the case of supporting the upcycle of each product. FIG. 5 will be described below. Note that an execution trigger of the processing is, for example, when the user or the employee detects a change or abnormality in the product or when the product monitoring program detects an abnormality or a sign of abnormality as a result of the product monitoring.

(Step S110) The article circulation support program diagnoses a product. The diagnosis is performed based on the product monitoring result stored in the product monitoring DB or the product history stored in the product history DB.

(Step S120) The article circulation support program determines a module to be removed (module to be removed) from the modules constituting the product based on the diagnosis result performed in step S110. For example, the module to be removed is a module that has reached the end of its life or has failed (or is close to that event).

(Step S130) The article circulation support program selects one or more modules compatible with the module to be removed (hereinafter, referred to as a compatible module), and calculates the degree of value improvement of the product value item assuming a case where each module is replaced with the selected module from the modules determined in S120. Note that, in a case where there are a plurality of product value items, the calculation of the degree of value improvement may be performed for each item, or may be performed only for an item designated at the time of executing the program in advance. In addition, the degree of value improvement may be indicated by a number, or may be contents other than the number such as “low to medium” or “improvement from standard A conformity to standard B conformity”.

(Step S140) The article circulation support program determines the module to be attached. The determination is made based on the following data.
The degree of value improvement calculated in step S130.

Although it is conceivable to determine the module by selecting from a plurality of candidates, the module may be determined by determining a specification of a module to be newly completed. From a different viewpoint, the processing of this step is to determine a module suitable for the module to be attached.

(Step S150) The article circulation support program causes the UI to display the model number, specification, or identifier of the module determined in step S140 as a module recommended as an attachment target. At this time, the degree of value improvement (related to the determined module) or the product history calculated in step S130 may be displayed on the UI as a recommended reason.

The above is the description of each step. With this processing, the user can grasp the degree of value improvement in accordance with the product value item (for example, power consumption amount or CO2 emission amount) in which the user is interested before the user upcycles the product based on the life, the failure, or the sign of that event as the trigger, such that the user can perform the product upcycle with more understanding.

When the user or the employee has already determined the module to be attached, step S130 may be executed only for the module, and the degree of value improvement and the history may be displayed in the manner of step S150. Note that in this processing, only step S110 and step S120 may be extracted. In addition, when the user or the employee has already determined the module to be removed, steps S110 and S120 may be omitted, alternatively, in this processing, the identifier of the module to be removed may be received from the user or the employee.

### <<<Calculation of Degree of Value Improvement of Product Value Item>>>

The degree of improvement in product value related to a predetermined value item (abbreviated as an item A) is calculated as follows. Note that a “value (item A)” used in the description means the value of the item A.

Degree of product value improvement (item A)=product value when attachment candidate module is attached (item A)—current product value (item A)

Here, the current product value (item A) is acquired from the product catalog DB.

Here, the product value (item A) when the attachment candidate module is attached is calculated, for example, as follows.

$${}^{*} Current product value ( item A ) - value of module to be removed ( item A ) + value of attachment candidate module ( item A ) is calculated .$$

The value (item A) is acquired by executing a simulation program (simulating chemical, dynamic, physical, machining, and program processing contents) on a product when the attachment candidate module is attached. During the simulation, the simulation program may further simulate the usage environment of the user by using the product monitoring data and the product history.
A relationship between the product and the module constituting the product (data related to other products may be included), a relationship between the product monitoring data or the product history, and the product value (item A) are learned in advance by machine learning, and the product value (item A) is estimated from the learning result. Note that the machine learning also includes calculation of a regression line.

Note that the degree of value improvement (item A) is not limited to the above, and a calculation method based on at least the following factors may be adopted.
Current Product Value (item A)
Data of the attachment candidate module (specification or value (item A)),
Product monitoring data or product history.

Note that the calculation method of the degree of value improvement of the product value item described here is also applicable to other examples.

### <<Support for Module Replacement for Purpose of Improving Product Value>>

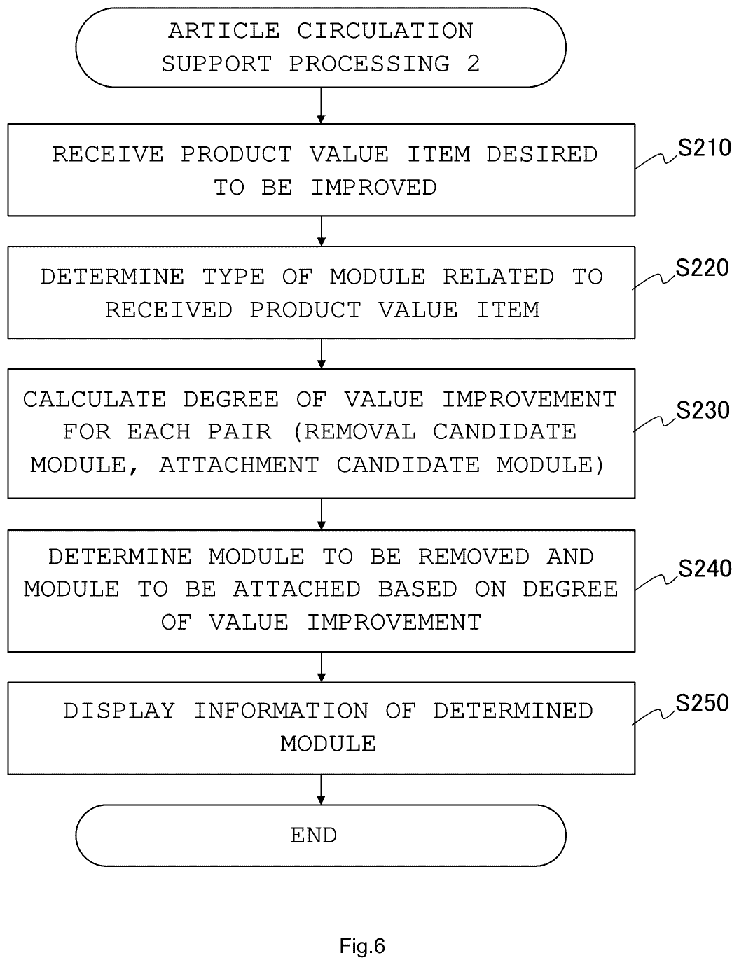

FIG. 6 is an example of module replacement support processing for the purpose of improving the product value. FIG. 6 will be described below. Note that examples of the execution trigger for the processing include, when the user desires or is considering product value improvement, or when the employee of the manufacturer makes a sales proposal.

(Step S210) The article circulation support program receives the product value item desired to be improved by the user or the user designated by the employee.

(Step S220) The article circulation support program determines a type of the module related to the designated product value item based on the data received in step S210.

(Step S230) The article circulation support program calculates the degree of value improvement for each pair (candidate for removal candidate module, candidate for attachment candidate module). Note that the removal candidate module is a module (included in the product) of the type determined in step S220, and the attachment candidate module is a module compatible with the removal candidate module. Note that the data used in the calculation of the degree of value improvement is as illustrated in the example of FIG. 5.

(Step S240) The article circulation support program determines the module to be removed and the module to be attached based on the degree of value improvement calculated in step S230. In the determination, for example, a pair having a higher degree of value improvement is selected.

(Step S250) The article circulation support program causes the UI to display the identifier of the module to be removed and the model number, specification, or identifier of the module to be attached as modules recommended as the module to be removed and the module to be attached. At this time, as the recommended reason, the degree of value improvement of the product calculated in step S240 (related to the determined pair of modules), the product passport, or the history may be displayed on the UI.

The above is the description of each step. With this processing, since the user can grasp in advance how much value will be improved by replacing which module for the product value item that the user wants to improve, the user can perform the upcycle with more understanding. In addition, the employee of the manufacturer can perform the upcycle sales more efficiently.

### <<Support of Module Replacement for Purpose of Continuing Update of Program or Data>>

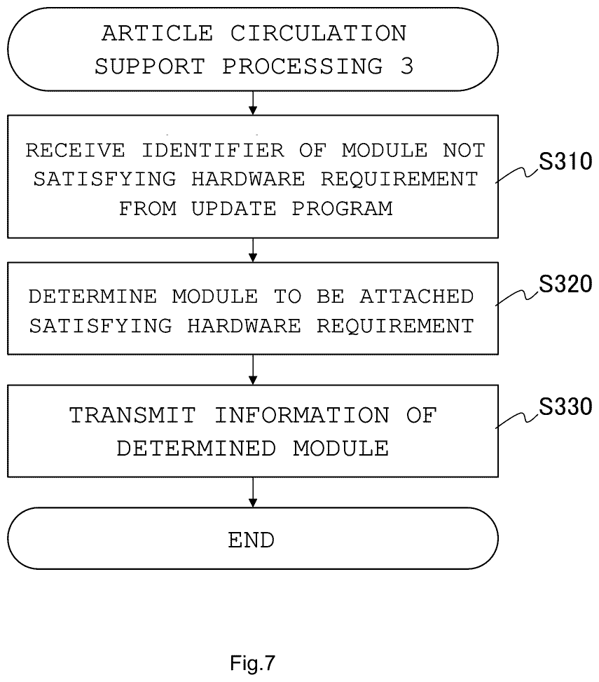

FIG. 7 is an example of module replacement support processing for the purpose of continuing update of the program or data. FIG. 7 will be described below. This processing is executed in cooperation with the update processing of the module-side program by the module-side program update program.

(Step S310) The article circulation support program receives an identifier of an update target module, which has failed to be updated without satisfying the hardware requirement, together with the hardware requirement from the module-side program update program (abbreviated as “update program” in FIG. 7).

(Step S320) The article circulation support program determines a module to be attached. This step is performed by selecting a module that satisfies the hardware requirement from the attachment candidate modules.

(Step S330) The article circulation support program causes the module-side program update program to display the following by transmitting the determined model number, specification, or identifier of the module to be attached to the module-side program update program.
Identifier of a module-side program whose update has failed
Identifier of a module whose update has failed
Model number, specification, or identifier of the module to be attached
Text indicating that the module-side program can be updated when the module is replaced with the module to be attached.

When the module-side program update program cannot display the data of the module to be attached, the article circulation support program may be in charge of the display.

### <<Support for Module Completion>>

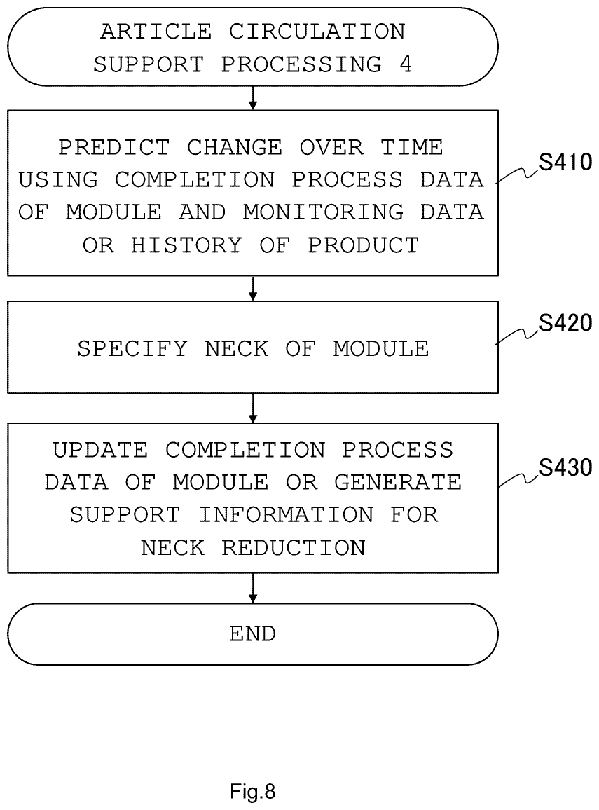

FIG. 8 is an example of module replacement support processing for the purpose of supporting completion of a module of a new product or completion of a module to be attached. Note that the module of the new product may be completed without performing the article circulation.

(Step S410) The article circulation support program predicts a post-use state of the module (for example, a state with a change over time or a high load) using the following data.
Completion process data of a module. Note that examples of the completion process data include data indicating design data (examples: CAD data and logic circuit data), a manufacturing process, an article circulation process, a part selection, and an inspection method from a hardware viewpoint. In the software viewpoint, examples of the completion process data include an execution code and a source code of the program.
Monitoring data or history of a product.

Note that the prediction may be performed by executing a simulation program (simulating chemical, dynamic, physical, machining, and program processing contents) or may be performed by machine learning (including a regression line).

(Step S420) The article circulation support program specifies a portion that becomes a neck of the module (for example, a portion that reaches the end of its life first, and a portion that becomes a performance bottleneck) based on the prediction result obtained in S320.

(Step S430) The article circulation support program performs at least one of the following.
Partial data (for example, in the case of the manufacturing process, manufacturing parameters, and design data of the neck portion and the periphery thereof) related to the neck portion included in the completion process data of the module is updated.
Assistance data for neck reduction of the module is generated. The support data is, for example, the neck portion or the partial data related to the neck portion.

The above is the description of each step. Note that the processing of the present example may be other processing as long as the processing generates at least one of the following update or update support data related to the module of the new product, the module to be attached, or the new product based on the product monitoring data or the product history:
design data, a manufacturing process, a part selection, or an inspection method.

This processing allows the manufacturer to complete a more valuable module.

### <<Generation of Product Passport of Product>>

The article circulation support program may generate the product passport of the product after the upcycle by performing the following processing. It is assumed that the product passport of the product before the upcycle (stored in the product catalog DB) is generated by the article circulation support program or the M-side processor system.

(Step A) The article circulation support program detects that the module to be removed has been removed from the product and the module to be attached has been attached. Note that the detection may be implemented, for example, by monitoring the product catalog DB, may be implemented by receiving the input of the user or the employee, or may be implemented by detecting the change in the product monitoring data.

(Step B) A product passport after the module to be attached is attached is generated. The generation method is, for example, as follows.
Delete or subtract the description related to the module to be removed from the product passport of the product before the upcycle (update only a difference part), and add the description related to the module to be attached.
Regenerate the product passport of the product after the upcycle from the product passport for the module to be attached (re-make the product from the beginning).

The above is the description of the processing. Thereby, the product passport of the upcycled product can be generated without delay.

The above is an example of the article circulation support program.

### <Further Cooperation Between Sharing Organization and Manufacturer>

One of the advantages of a product appearance upcycle for the sharing organization is that it is expected that customers will use products they rent with great care. This is because when there is no (or less) scratch in the appearance upcycle at the time of product rental, the scratch made by the customer at the time of product return can be more easily determined by visual inspection or an inspection device. As a result, the amount of impact applied to the product that causes scratches can be reduced, leading to long use of the product.

It should be noted that repair using the facility for promoting the self-repairing material with respect to the module completed using the self-repairing material is suitable for repairing the product appearance. Note that the repair may be performed by the sharing organization. It is expected that the returned product will be rented out to another customer after the repair, and the product will be used again with great care.

### <Form of More Developed Ecosystem>

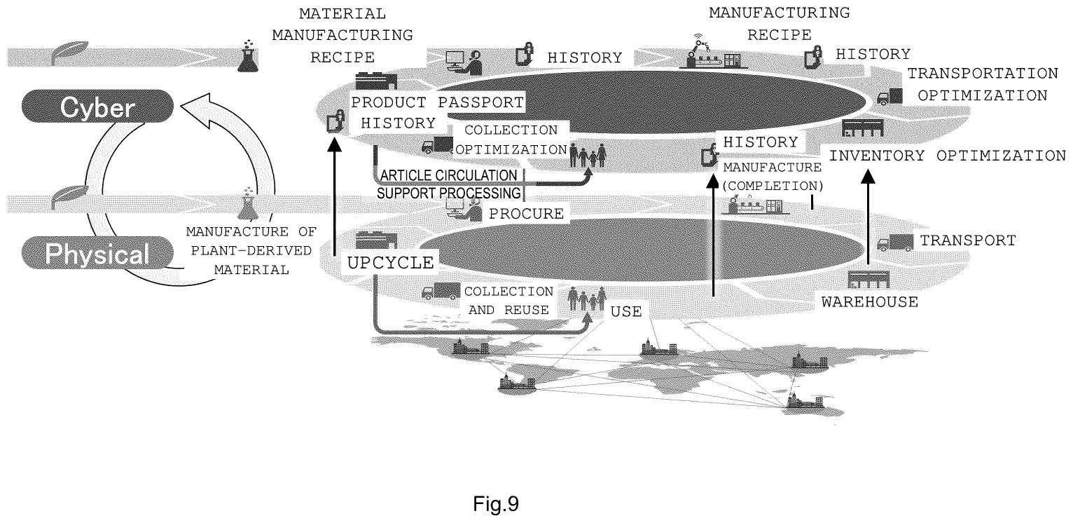

The circulation method and system described above can also be applied to the developed ecosystem described below. FIG. 9 is a diagram illustrating a concept of a developed ecosystem. The developed ecosystem is a sustainable system capable of pursuing diverse life cycles by upcycling resources and functions (some of the functions are provided by products). In order to implement such a developed ecosystem, it is important to aim for triple zero (zero disposal, zero carbon (zero CO2), and zero environmental impact). The product upcycle is as described above.

In aiming for the triple zero, it is desirable to operate a cyber-physical system (CPS) targeting the entire developed ecosystem. Note that the CPS in this specification refers to a system that “collects various data in the real world (physical space) by a sensor network or the like, and analyzes/converts it into knowledge using a large-scale data processing technique or the like in a cyberspace. Then, the data/value created there is used to activate industry and solve social problems”. Here, in the present specification, the activation of the industry includes at least the article manufacturing and the activation of the article circulation. In addition, in the present specification, the example of the social problem to be solved is the aforementioned triple zero.

Note that in the physical space:
a plant-derived material from a plant is manufactured,
the plant-derived material is procured by a manufacturer,
a product using at least a material that is either the plant-derived material or a recycled material is manufacture (or completed),
the manufactured product is transported to a warehouse,
a user uses the product delivered from the warehouse,
an article (a product or a module) discarded or removed after the start of use is collected,
the collected article is upcycled to complete a recycled material or an upgraded product, and
the user reuses the upgraded product.

Note that a processor system:
generates a material history from the manufacturing process and plant data of the plant-derived material (a material history of the recycled material will be explained later),
generates a manufacturing recipe that is a recipe at the time of manufacturing the article based on the material history,
generates an article history from the material history and the manufacturing process of the article, and
performs the transportation of the article and optimization calculation of inventory.

As described above, the processor system acquires the product history by monitoring the product.

Note that a processor system:
optimizes collection and delivery of an article discarded by a customer or an article returned to a sharing organization after use,
performs the aforementioned article circulation support processing for upcycling the collected article,
generates a product passport in cooperation with product upgrade by executing the article circulation support processing,
generates a manufacturing recipe for manufacturing a recycled material from the collected article based on an article history, and
generates a material history of the recycled material based on the article history and the manufacturing recipe of the recycled material.

The above is a description of the form of the more developed ecosystem. Note that, in each manufacturing process, by monitoring or inspecting the article during or after manufacturing, trust data for quality assurance of the article may be generated.

### <Variations>

The present embodiment has been described above. Note that the following variations may be applied to the above embodiment.
The more developed ecosystem may not involve the product upgrade.
The article circulation support program may be stored in a nonvolatile memory medium readable by the processor system.

### SUMMARY

As described above, in the present specification, after the start of use of a product composed of a plurality of modules, a module to be removed included in the product is replaced with a new module (a module of which a value has improved in a predetermined product value item compared to the module to be removed). It has been described that the new module is a module completed by performing the article circulation of the module removed from the product or another product. In addition, the present specification has been described from various viewpoints, but some viewpoints thereof are as follows.

### <<Viewpoint 1>>

A circulation method of a product including a plurality of modules or an ecosystem:
removes a module to be removed from a first product that has started to be used; and
attaches a new module to the first product, the new module being a substitute for the module to be removed,
the new module being a module of which a value has improved in a predetermined product value item compared to the module to be removed, and
the new module being a module completed by performing article circulation of at least one of the following:
the module to be removed related to the first product; and
a module removed from a second product different from the first product.

### <<Viewpoint 2>>

The article circulation is at least one action of reuse, repair, remanufacturing, and refurbishing, and the product value item may be at least one of a function, a performance, a durability, an appearance, or a life of a product.

### <<Viewpoint 3>>

The module is composed of one or more parts, and a method or an ecosystem may:
determine parts constituting the module based on at least a durability, a life, an appearance, or a relevance to a function provided by the product of the part at a time of designing the product.

### <<Viewpoint 4>>

A method or an ecosystem:
completes an attachment candidate module, which is a module that is a plurality of attachment candidates of a same type as the new module, by article circulation, and
prior to attachment of the new module, a processor system may:
(A) acquire a history related to the first product or the second product;
(B) diagnose the first product based on the monitoring result or the history;
(C) determine the module to be removed from a plurality of modules constituting the first product based on a diagnosis result;
(D) calculate, for each of the attachment candidate modules, a degree of value improvement of a predetermined product value item assuming a case of attachment to the first product based on the following:
a value of the predetermined product value item of the first product;
a specification or a value of a predetermined value item of the plurality of modules that are the attachment candidates; and
the monitoring result or the history; and
(E) determine a module suitable for the new module from the attachment candidate modules based on the degree of value improvement.
   <<Viewpoint 4b>>

The acquisition of the history related to the first product or the second product may be at least one of the following.

Monitoring the first product or the second product, and
receiving, from a sharing organization, a maintenance history or a rental history related to the first product or the second product.

### <<Viewpoint 5>>

The determining of (E) may be further performed based on a cost or an environmental load related to the use of the first product.

### <<Viewpoint 6>>

A processor system may:
(1) receive a product value item to be improved;
(2) determine a type of a module related to the received product value item;
(3) create a plurality of pairs of a removal candidate module and an attachment candidate module based on the type determined in (2), here, the removal candidate module is a module to be a candidate to be removed from the first product, and here, the attachment candidate module is a module completed by article circulation to be a candidate to be attached to the first product;
(4) calculate, for each of the created pairs, a degree of value improvement of a predetermined product value item assuming a case where the removal candidate module is removed from the first product and the attachment candidate module is attached;
(5) determine the module to be removed from the removal candidate module based on the degree of value improvement; and
(6) determine the new module from the attachment candidate module based on the degree of value improvement.

### <<Viewpoint 7>>

A processor system may:
(i) receive an identifier of a module to be updated for which a program update has failed and a hardware requirement of the failed program update; and
(ii) select, from the attachment candidate modules, the new module that satisfies the hardware requirement.

### <<Viewpoint 8>>

A processor system may:
(F) update at least one of the following or generate support data for update regarding the new module or a new product based on the monitoring result or the history:
design data; a manufacturing process; a part selection; or an inspection method.

### <<Viewpoint 9>>

A processor system may:
(F) generate a product passport of a first product related to the first product; and
(G) generate a product passport related to the first product after attachment of the new module, based on a specification of the new module or a second product passport of the new module.

### <<Viewpoint 10>>

The removal is performed after the first product is returned from a first user to a sharing organization,
the new module relates to at least an appearance of the product and is an appearance part made of a self-repairing material or includes the appearance part, and
the first product after the attachment may be rented from the sharing organization to the first user or another user.

### <<Viewpoint 11>>

A processor system that supports product circulation, including:
one or more processors; and
one or more memory resources storing an article circulation support program, or the article circulation support program may:
generate, after start of use of a product including a plurality of modules, data for supporting replacement of a module to be removed included in the product with a new module having the following characteristics:
a module of which a value has improved in a predetermined product value item compared to the module to be removed; and
a module completed by article circulation of a module removed from a first product or another product.

Note that the present invention is not limited to the above-described embodiments and modifications, and various modifications are included within the scope of the same technical idea. For example, the above-described embodiments have been described in detail for easy understanding of the present invention, and are not necessarily limited to those having all the described configurations.

In addition, a part of the configuration of a certain embodiment can be replaced with the configuration of another embodiment, and the configuration of another embodiment can be added to the configuration of a certain embodiment. In addition, it is possible to add, delete, and replace other configurations for a part of the configuration of each embodiment.

In addition, in the above description, control lines and information lines considered to be necessary for the description are illustrated, and all control lines and information lines in a product are not necessarily illustrated. In practice, it may be considered that almost all the configurations are connected to each other.

### REFERENCE SIGNS LIST

PD1 Product
PD2 Product
MOD1 Module
MOD2 Module

1. A circulation method of a product including a plurality of modules, the method comprising:
removing a module to be removed from a first product that has started to be used; and
attaching a new module to the first product, the new module being a substitute for the module to be removed,
the new module being a module of which a value has improved in a predetermined product value item compared to the module to be removed, and
the new module being a module completed by performing article circulation of at least one of the following:
the module to be removed related to the first product; and
a module removed from a second product different from the first product.

2. The method according to claim 1, wherein
the article circulation is at least one action of reuse, repair, remanufacturing, and refurbishing, and
the product value item is at least one of a function, a performance, a durability, an appearance, or a life of a product.

3. The method according to claim 1, wherein
the module includes one or more parts,
the method comprising
determining parts constituting the module based on at least a durability, a life, an appearance, or a relevance to a function provided by the product of the part at a time of designing the product.

4. The method according to claim 1, comprising
completing an attachment candidate module, which is a module that is a plurality of attachment candidates of a same type as the new module, by article circulation, wherein
prior to attachment of the new module, a processor system is configured to:
(A) acquire a history related to the first product or the second product by performing at least one of the following:
monitoring the first product or the second product;
receiving, from a sharing organization, a maintenance history or a rental history related to the first product or the second product; and
receiving an input related to the first product or the second product from a user or an employee;
(B) diagnose the first product based on the monitoring result or the history;
(C) determine the module to be removed from a plurality of modules constituting the first product based on a diagnosis result;
(D) calculate, for each of the attachment candidate modules, a degree of value improvement of a predetermined product value item assuming a case of attachment to the first product based on the following:
a value of the predetermined product value item of the first product;
a specification or a value of a predetermined value item of the plurality of modules that are the attachment candidates; and
the monitoring result or the history; and
(E) determine a module suitable for the new module from the attachment candidate modules based on the degree of value improvement.

5. The method according to claim 4, wherein
the determining of (E) is further performed based on a cost or an environmental load related to use of the first product.

6. The method according to claim 1, wherein
the method, prior to attachment of the new module, causes a processor system to:
(1) receive a product value item to be improved;
(2) determine a type of a module related to the received product value item;
(3) create a plurality of pairs of a removal candidate module and an attachment candidate module based on the type determined in (2), wherein the removal candidate module is a module to be a candidate to be removed from the first product, and the attachment candidate module is a module completed by article circulation to be a candidate to be attached to the first product;
(4) calculate, for each of the created pairs, a degree of value improvement of a predetermined product value item assuming a case where the removal candidate module is removed from the first product and the attachment candidate module is attached;
(5) determine the module to be removed from the removal candidate module based on the degree of value improvement; and
(6) determine the new module from the attachment candidate module based on the degree of value improvement.

7. The method according to claim 1, comprising
completing an attachment candidate module, which is a module that is a plurality of attachment candidates of a same type as the new module, by article circulation, wherein
prior to attachment of the new module, the processor system is configured to:
(i) receive an identifier of a module to be updated for which a program update has failed and a hardware requirement of the failed program update; and
(ii) select, from the attachment candidate modules, the new module that satisfies the hardware requirement.

8. The method according to claim 1, wherein
the method causes a processor system to:
(A) acquire a history related to the first product or the second product by performing at least one of the following:
monitoring the first product or the second product;
receiving, from a sharing organization, a maintenance history or a rental history related to the first product or the second product; and
receiving an input related to the first product or the second product from a user or an employee; and
(F) update at least one of the following or generate support data for update regarding the new module or a new product based on the monitoring result or the history:
design data; a manufacturing process; a part selection;
or an inspection method.

9. The method according to claim 1, wherein
the method causes a processor system to:
(F) generate a product passport of the first product related to the first product; and
(G) generate a product passport related to the first product after attachment of the new module, based on a specification of the new module or a second product passport of the new module.

10. The method according to claim 1, wherein
the removal is performed after the first product is returned from a first user to a sharing organization,
the new module relates to at least an appearance of the product and is an appearance part made of a self-repairing material or includes the appearance part,
the method comprising
renting the first product after the attachment from the sharing organization to the first user or another user.

11. A processor system that supports product circulation, the system comprising:
one or more processors; and
one or more memory resources storing an article circulation support program, wherein
the processor is configured to:
generate, after start of use of a product including a plurality of modules, data for supporting by replacement of a module to be removed included in the product with a new module having the following characteristics:
a module of which a value has improved in a predetermined product value item compared to the module to be removed; and
a module completed by article circulation of a module removed from a first product or another product.

12. A processor system that supports product circulation, the system comprising:
one or more processors; and
one or more memory resources storing an article circulation support program, wherein
the circulation support includes, after start of use of the product including a plurality of modules, replacing a module to be removed included in a product with a new module having the following characteristics:
a module of which a value has improved in a predetermined product value item compared to the module to be removed; and
a module completed by article circulation of a module removed from a first product or a second product that is another product, and
the one or more processors execute the article circulation support program to:
(A) acquire a history related to the first product or the second product by performing at least one of the following:
monitoring the first product or the second product;
receiving, from a sharing organization, a maintenance history or a rental history related to the first product or the second product; and
receiving an input related to the first product or the second product from a user or an employee;
(B) diagnose the first product based on the monitoring result or the history;
(C) determine the module to be removed from a plurality of modules constituting the first product based on a diagnosis result;
(D) calculate, for each of attachment candidate modules, a degree of value improvement of a predetermined product value item assuming a case of attachment to the first product based on the following:
a value of the predetermined product value item of the first product;
a specification or a value of a predetermined value item of the plurality of modules that are the attachment candidates; and
the monitoring result or the history; and
(E) determine a module suitable for the new module from the attachment candidate modules based on the degree of value improvement,
the attachment candidate module being a module completed by article circulation, that is a plurality of attachment candidates of a same type as the new module.

13. A processor system that supports product circulation, the system comprising:
one or more processors; and
one or more memory resources storing an article circulation support program, wherein
the circulation support includes replacing a module to be removed included in a product with a new module having the following characteristics after the start of use of the product including a plurality of modules:
a module of which a value has improved in a predetermined product value item compared to the module to be removed; and
a module completed by article circulation of a module removed from a first product or another product, and
the one or more processors execute the article circulation support program to:
(1) receive a product value item to be improved;
(2) determine a type of a module related to the received product value item;
(3) create a plurality of pairs of a removal candidate module and an attachment candidate module based on the type determined in (2), wherein the removal candidate module is a module to be a candidate to be removed from the first product, and the attachment candidate module is a module completed by the article circulation to be a candidate to be attached to the first product;
(4) calculate, for each of the created pairs, a degree of value improvement of a predetermined product value item assuming a case where the removal candidate module is removed from the first product and the attachment candidate module is attached;
(5) determine the module to be removed from the removal candidate module based on the degree of value improvement; and
(6) determine the new module from the attachment candidate module based on the degree of value improvement.
